(19) United States
(12) Patent Application Publication
(10) Pub. No.: US 2020/0401928 A1
(43) Pub. Date: Dec. 24, 2020

(54) TERM-UID GENERATION, MAPPING AND LOOKUP

(71) Applicant: Microsoft Technology Licensing, LLC, Redmond, WA (US)

(72) Inventor: Sanjay Sachdev, San Jose, CA (US)

(73) Assignee: Microsoft Technology Licensing, LLC, Redmond, WA (US)

(21) Appl. No.: 16/445,408

(22) Filed: Jun. 19, 2019

(51) Int. Cl. G06N 20/00; G06F 16/903; H04L 9/06

(52) U.S. Cl. CPC G06N 20/00; H04L 2209/38; H04L 9/0643; G06F 16/90335

(57) ABSTRACT

The disclosed embodiments provide a system for processing data. During operation, the system applies a hash function to a first term to produce a first index into a term offset table. Next, the system obtains, from a first entry at the first index in the term offset table, a first offset of a first record in a log-structured record store. The system retrieves a first UID for the first term from the first record and/or another record that is linked to the first record via a corresponding mapping to the first index. Finally, the system outputs the first UID in association with the first term.

### BACKGROUND

### Field

The disclosed embodiments relate to representations of terms used in machine learning. More specifically, the disclosed embodiments relate to techniques for generating, mapping, and looking up unique identifiers (UIDs) for machine learning terms.

### Related Art

Machine learning and/or analytics allow trends, patterns, relationships, and/or other attributes related to large sets of complex, interconnected, and/or multidimensional data to be discovered. In turn, the discovered information can be used to gain insights and/or guide decisions and/or actions related to the data. For example, machine learning involves training regression models, artificial neural networks, decision trees, support vector machines, deep learning models, and/or other types of machine learning models using labeled training data. Output from the trained machine learning models is then used to assess risk, detect fraud, generate recommendations, perform root cause analysis of anomalies, and/or provide other types of enhancements or improvements to applications, electronic devices, and/or user experiences.

However, significant increases in the size of data sets have resulted in difficulties associated with collecting, storing, managing, transferring, sharing, analyzing, and/or visualizing the data in a timely manner. For example, conventional software tools and/or storage mechanisms are unable to handle petabytes or exabytes of loosely structured data that is generated on a daily and/or continuous basis from multiple, heterogeneous sources. Instead, management and processing of “big data” commonly require massively parallel and/or distributed software running on a large number of physical servers.

Consequently, big data analytics may be facilitated by mechanisms for efficiently collecting, storing, managing, compressing, transferring, sharing, analyzing, processing, defining, and/or visualizing large data sets.

### BRIEF DESCRIPTION OF THE FIGURES

FIG. 1 shows a schematic of a system in accordance with the disclosed embodiments.

FIG. 2 shows a system for processing data in accordance with the disclosed embodiments.

FIG. 3A shows an example term offset store, record store, and identifier (ID) offset store in accordance with the disclosed embodiments.

FIG. 3B shows an example record in a log-structured record store in accordance with the disclosed embodiments.

FIG. 4 shows a flowchart illustrating a process of performing a forward lookup of a UID for a term in accordance with the disclosed embodiments.

FIG. 5 shows a flowchart illustrating a process of storing a term-UID mapping in accordance with the disclosed embodiments.

FIG. 6 shows a flowchart illustrating a process of performing a reverse lookup of a term for a UID in accordance with the disclosed embodiments.

FIG. 7 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

### Overview

The disclosed embodiments provide a method, apparatus, and system for performing generation, mapping, and lookup of unique identifiers (UIDs) for terms. In these embodiments, terms include strings representing entities, dimensions, and/or attributes used within a given domain. For example, terms associated with profiles in an online network include values of titles, locations, industries, companies, skills, schools, degrees, awards, certifications, and/or other attributes from the profiles.

To reduce storage and/or computational overhead associated with strings, each term is assigned a numeric UID. For example, each distinct term used within a given context (e.g., team, project, application, model, workflow, pipeline, service, data store, etc.) is assigned an integer UID. The integer UID is subsequently used as a compact representation of the term in lieu of the string in storage, retrieval, communication, machine learning, and/or other use cases related to the term.

In one or more embodiments, the mappings are stored in an index structure that includes an in-memory term offset table and a memory-mapped log-structured record store. The term offset table stores offsets into records in the log-structured record store. A hash function is applied to each term to produce an integer that is an index into the term offset table. The term offset table entry at the index stores the offset into the log-structured record store of the last record that stores data for a term that is mapped to the index by the hash function.

The log-structured record store includes records that store UIDs in increasing sequential order (i.e., so that the first record contains the lowest numeric UID assigned to a term and the last record contains the highest numeric UID assigned to a term). Each record in the log-structured record store also includes a term to which the corresponding UID is mapped, a reference or delta to the preceding record in the log-structured record store, as well as a reference to a previous record storing a term that produces the same term offset table index. In other words, multiple terms that map to the same term offset table index are stored as a linked chain of records in the log-structured record store. As a result, a UID for a given term is retrieved by using the hash function to calculate an index into the term offset table from the term, obtaining an offset into the log-structured record store from the term offset table entry at the index, and searching backwards through the linked chain of records starting with the record at the offset until a record for the term is found.

To perform a reverse lookup of a term for a given UID, the log-structured record store is searched using a linked chain of records that starts at the last record in the log-structured record store. Once the chain reaches a record with a UID that is lower than the desired UID, records between the record and a subsequent record that links to the record in the chain are scanned until the desired UID is found, and the term is retrieved from the record.

To expedite the reverse lookup of the term for the UID, an additional in-memory ID offset table is optionally added to the data structure. An index into the ID offset table is calculated as the UID modulo the size of the ID table. The ID offset table entry at the index stores an offset into the log-structured record store, and the record at the offset stores the latest UID that maps to the index in the ID offset table. Each record in the log-structured record store is additionally updated to include a reference to a previous record storing an earlier UID that produces the same ID offset table index, so that multiple UIDs that map to the same ID offset table index are stored as a linked chain of records in the log-structured record store. In turn, the chain is searched backwards (i.e., from latest record to earliest record) to find a record containing the desired UID and corresponding term.

By storing mappings of terms to UIDs in a memory-mapped log-structured file, the disclosed embodiments reduce the memory footprint of the mappings. At the same time, the use of an in-memory term offset table and/or ID offset table with corresponding chains of references within records in the log-structured file expedites lookup of UIDs for terms (or terms for UIDs) without incurring significant memory overhead.

In contrast, conventional techniques store term-UID mappings in an in-memory two-way concurrent map. The two-way concurrent map includes one set of mappings from string terms to integer UIDs and another set of mappings from integer UIDs to string terms. Because two mappings are maintained for each term-UID pair, the two-way concurrent map occupies a significant amount of memory, which can lead to unexpected latency during garbage collection cycles and prevent other processes, services, and/or applications from using the memory.

The conventional techniques also, or instead, use a hash function to compute an integer hash value representing an ID from a string term. In these instances, the uniqueness of the ID cannot be guaranteed, since the likelihood of hash collisions increases significantly with the number of terms. In addition, the hash function is used in lieu of storing mappings between terms and IDs, which prevents reverse lookup of terms given the IDs. Such lack of reverse lookup additionally prevents the context associated with a given ID from being established, which interferes with debugging, troubleshooting, and/or analysis related to the ID and/or use of the ID as a representation of the corresponding term. Consequently, the disclosed embodiments provide technological improvements in applications, tools, computer systems, and/or environments for generating, storing, and/or looking up term-UID mappings.

### Term-UID Generation, Mapping and Lookup

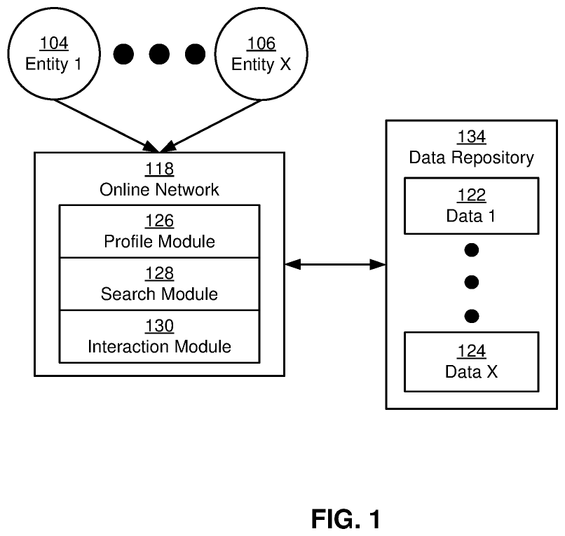

FIG. 1 shows a schematic of a system in accordance with the disclosed embodiments. As shown in FIG. 1, the system includes an online network 118 and/or other user community. For example, online network 118 includes an online professional network that is used by a set of entities (e.g., entity 1 104, entity x 106) to interact with one another in a professional and/or business context.

The entities include users that use online network 118 to establish and maintain professional connections, list work and community experience, endorse and/or recommend one another, search and apply for jobs, and/or perform other actions. The entities also, or instead, include companies, employers, and/or recruiters that use online network 118 to list jobs, search for potential candidates, provide business-related updates to users, advertise, and/or take other action.

Online network 118 includes a profile module 126 that allows the entities to create and edit profiles containing information related to the entities' professional and/or industry backgrounds, experiences, summaries, job titles, projects, skills, and so on. Profile module 126 also allows the entities to view the profiles of other entities in online network 118.

Profile module 126 also, or instead, includes mechanisms for assisting the entities with profile completion. For example, profile module 126 may suggest industries, skills, companies, schools, publications, patents, certifications, and/or other types of attributes to the entities as potential additions to the entities' profiles. The suggestions may be based on predictions of missing fields, such as predicting an entity's industry based on other information in the entity's profile. The suggestions may also be used to correct existing fields, such as correcting the spelling of a company name in the profile. The suggestions may further be used to clarify existing attributes, such as changing the entity's title of “manager” to “engineering manager” based on the entity's work experience.

Online network 118 also includes a search module 128 that allows the entities to search online network 118 for people, companies, jobs, and/or other job- or business-related information. For example, the entities may input one or more keywords into a search bar to find profiles, job postings, job candidates, articles, and/or other information that includes and/or otherwise matches the keyword(s). The entities may additionally use an “Advanced Search” feature in online network 118 to search for profiles, jobs, and/or information by categories such as first name, last name, title, company, school, location, interests, relationship, skills, industry, groups, salary, experience level, etc.

Online network 118 further includes an interaction module 130 that allows the entities to interact with one another on online network 118. For example, interaction module 130 may allow an entity to add other entities as connections, follow other entities, send and receive emails or messages with other entities, join groups, and/or interact with (e.g., create, share, re-share, like, and/or comment on) posts from other entities.

Those skilled in the art will appreciate that online network 118 may include other components and/or modules. For example, online network 118 may include a homepage, landing page, and/or content feed that provides the entities the latest posts, articles, and/or updates from the entities' connections and/or groups. Similarly, online network 118 may include features or mechanisms for recommending connections, job postings, articles, and/or groups to the entities.

In one or more embodiments, data (e.g., data 1 122, data x 124) related to the entities' profiles and activities on online network 118 is aggregated into a data repository 134 for subsequent retrieval and use. For example, each profile update, profile view, connection, follow, post, comment, like, share, search, click, message, interaction with a group, address book interaction, response to a recommendation, purchase, and/or other action performed by an entity in online network 118 is tracked and stored in a database, data warehouse, cloud storage, and/or other data-storage mechanism providing data repository 134.

Data in data repository 134 is then used to generate recommendations and/or other insights related to listings of jobs or opportunities within online network 118. For example, one or more components of online network 118 may track searches, clicks, views, text input, conversions, and/or other feedback during the entities' interaction with a job search tool in online network 118. The feedback may be stored in data repository 134 and used as training data for one or more machine learning models, and the output of the machine learning model(s) may be used to display and/or otherwise recommend jobs, advertisements, posts, articles, connections, products, companies, groups, and/or other types of content, entities, or actions to members of online network 118.

More specifically, data in data repository 134 and one or more machine learning models are used to produce rankings related to matching candidates with jobs or opportunities listed within or outside online network 118. In some embodiments, the candidates include users who have viewed, searched for, or applied to jobs, positions, roles, and/or opportunities, within or outside online network 118. The candidates also, or instead, include users and/or members of online network 118 with skills, work experience, and/or other attributes or qualifications that match the corresponding jobs, positions, roles, and/or opportunities.

After the candidates are identified, profile and/or activity data of the candidates are inputted into the machine learning model(s), along with features and/or characteristics of the corresponding opportunities (e.g., required or desired skills, education, experience, industry, title, etc.). The machine learning model(s) output scores representing the strength of the candidates with respect to the opportunities and/or qualifications related to the opportunities (e.g., skills, current position, previous positions, overall qualifications, etc.). For example, the machine learning model(s) may generate scores based on similarities between the candidates' profile data with online network 118 and descriptions of the opportunities. The model(s) may further adjust the scores based on social and/or other validation of the candidates' profile data (e.g., endorsements of skills, recommendations, accomplishments, awards, etc.).

In turn, rankings based on the scores and/or associated insights improve the quality of the candidates, recommendations of opportunities to the candidates, and/or recommendations of candidates for opportunities. Such rankings may also, or instead, increase user activity with online network 118 and/or guide the decisions of candidates and/or moderators involved in screening for or placing the opportunities (e.g., hiring managers, recruiters, human resources professionals, etc.). For example, one or more components of online network 118 may display and/or otherwise output a member's position (e.g., top 10%, top 20 out of 138, etc.) in a ranking of candidates for a job to encourage the member to apply for jobs in which the member is highly ranked. In a second example, the component(s) may account for a candidate's relative position in rankings for a set of jobs during ordering of the jobs as search results in response to a job search by the candidate. In a third example, the component(s) may output a ranking of candidates for a given set of job qualifications as search results to a recruiter after the recruiter performs a search with the job qualifications included as parameters of the search. In a fourth example, the component(s) may recommend jobs to a candidate based on the predicted relevance or attractiveness of the jobs to the candidate and/or the candidate's likelihood of applying to the jobs.

Those skilled in the art will appreciate that online network 118 and/or other online systems include large numbers of string-based terms representing titles, industries, skills, educational attributes, positions, and/or other attributes or dimensions of candidate profiles, jobs, and/or other entities for which machine learning and/or inference are performed. To reduce overhead associated with storing, retrieving, transmitting, and/or otherwise using the terms, each term is mapped to a numeric unique identifier (UID) such as a non-negative integer value, and the UID is used as a compact representation of the term.

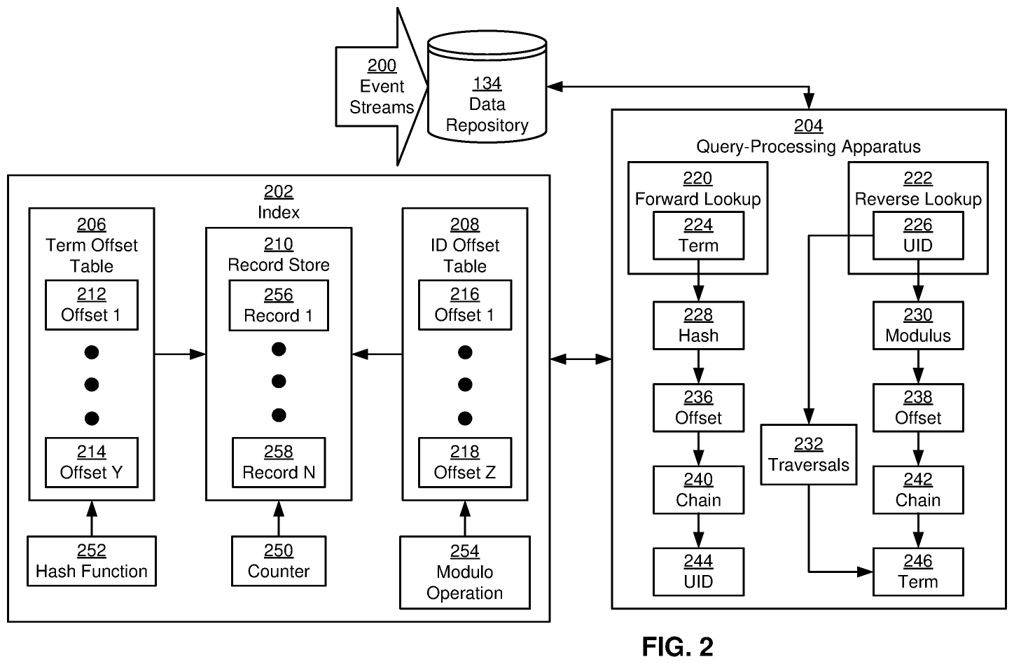

In one or more embodiments, online network 118 includes functionality to improve the creation, storage, and/or retrieval of mappings between terms and UIDs. As shown in FIG. 2, data in data repository 134 is updated using records of recent activity received over one or more event streams 200. For example, event streams 200 are generated and/or maintained using a distributed streaming platform such as Apache Kafka (Kafka™ is a registered trademark of the Apache Software Foundation). One or more event streams 200 are also, or instead, provided by a change data capture (CDC) pipeline that propagates changes to the data from a source of truth for the data. For example, an event containing a record of a recent profile update, job search, job view, job application, response to a job application, connection invitation, post, like, comment, share, and/or other recent member activity within or outside the community may be generated in response to the activity. The record may then be propagated to components subscribing to event streams 200 on a nearline basis.

In one or more embodiments, data in data repository 134 is standardized before the data is used by components of the system. For example, skills in data repository 134 are organized into a hierarchical taxonomy that is stored in data repository 134 and/or another repository. The taxonomy models relationships between skills (e.g., “Java programming” is related to or a subset of “software engineering”) and/or standardize identical or highly related skills (e.g., “Java programming,” “Java development,” “Android development,” and “Java programming language” are standardized to “Java”).

In another example, locations in data repository 134 include cities, metropolitan areas, states, countries, continents, and/or other standardized geographical regions. Like standardized skills, the locations can be organized into a hierarchical taxonomy (e.g., cities are organized under states, which are organized under countries, which are organized under continents, etc.).

In a third example, data repository 134 includes standardized company names for a set of known and/or verified companies associated with the members and/or jobs. In a fourth example, data repository 134 includes standardized titles, seniorities, and/or industries for various jobs, members, and/or companies in the online network. In a fifth example, data repository 134 includes standardized time periods (e.g., daily, weekly, monthly, quarterly, yearly, etc.) that can be used to retrieve profile data 216, user activity 218, and/or other data that is represented by the time periods (e.g., starting a job in a given month or year, graduating from university within a five-year span, job listings posted within a two-week period, etc.). In a sixth example, data repository 134 includes standardized job functions such as “accounting,” “consulting,” “education,” “engineering,” “finance,” “healthcare services,” “information technology,” “legal,” “operations,” “real estate,” “research,” and/or “sales.”

In some embodiments, standardized attributes in data repository 134 are represented by unique identifiers (IDs) in the corresponding taxonomies. For example, each standardized skill is represented by a numeric skill ID in data repository 134, each standardized title is represented by a numeric title ID in data repository 134, each standardized location is represented by a numeric location ID in data repository 134, and/or each standardized company name (e.g., for companies that exceed a certain size and/or level of exposure in the online system) is represented by a numeric company ID in data repository 134.

As mentioned above, other string-based terms in data repository 134 are also mapped to numeric UIDs to reduce overhead associated with storing, transmitting, retrieving, and/or using the terms. More specifically, a query-processing apparatus 204 uses an index 202 to generate, store, and/or perform lookups of mappings of terms (e.g., terms 224 and 246) in data repository 134 to UIDs (e.g., UIDs 226 and 244) for the terms. As shown in FIG. 2, index 202 includes a log-structured record store 210, a term offset table 206, and an identifier (ID) offset table 208.

In some embodiments, record store 210 includes a log or list of records (e.g., record 1 256, record n 258) that store mappings of terms to UIDs. For example, each record in record store 210 includes an integer UID, followed by a number of bytes storing a string representing the corresponding term. Within record store 210, the records are ordered by ascending UID, and new records are appended to the end of record store 210. As a result, the first record in record store 210 is the oldest record and contains the lowest UID, and the last record in record store 210 is the newest record and contains the highest UID.

In some embodiments, query-processing apparatus 204 writes records in log-structured record store 210 to one or more memory-mapped files. As a result, log-structured record store 210 occupies less memory than conventional techniques that store mappings of terms to UIDs in memory.

To improve a forward lookup 220 of a UID 244 for a given term 224, query-processing apparatus 204 generates an in-memory term offset table 206 that stores a set of offsets (e.g., offset 1 212, offset y 214) into record store 210. More specifically, query-processing apparatus 204 applies a hash function 252 to each term to produce an integer hash 228 that is used as an index into term offset table 206. Query-processing apparatus 204 also stores, in a term offset table 206 entry at a given index, the offset of the latest record in record store 210 that includes a term that is mapped to the index by hash function 252. Query-processing apparatus 204 further stores, in each record in record store 210, a field containing a reference to a previous record containing a term value that maps to the same term offset table 206 index, so that multiple terms that generate the same hash 228 and thus map to the same term offset table 206 index are stored as a linked chain of records in record store 210. When a record is the first record in record store 210 that maps to a given term offset table 206 index, the field is set to 0 and/or another value that indicates that the record is the beginning of the chain.

Query-processing apparatus 204 also includes functionality to perform a reverse lookup 222 that retrieves a term 246 for a given UID 226. In some embodiments, query-processing apparatus 204 generates an in-memory ID offset table 206 that stores another set of offsets (e.g., offset 1 216, offset z 218) into record store 210. Query-processing apparatus 204 applies a modulo operation 254 to each ID to produce an integer modulus 230 that is used as an index into ID offset table 208. As a result, modulo operation 254 has a divisor that equals the number of entries in ID offset table 208, and each record in record store 210 is separated from the previous (or next) record with the same index into ID offset table 208 by a number of records that is equal to the divisor.

Query-processing apparatus 204 also stores, in an ID offset table 208 entry at a given index, the offset of the latest record in record store 210 that includes a term that is mapped to the index by modulo operation 254. Query-processing apparatus 204 further stores, in each record in record store 210, a reference to a previous record containing a UID value that maps to the same ID offset table 208 index, so that multiple UIDs that map to the same ID offset table 208 index are stored as a linked chain of records in record store 210. When a record is the first record in record store 210 that maps to a given ID offset table 208 index, the field is set to 0 and/or another value that indicates that the record is the beginning of the chain.

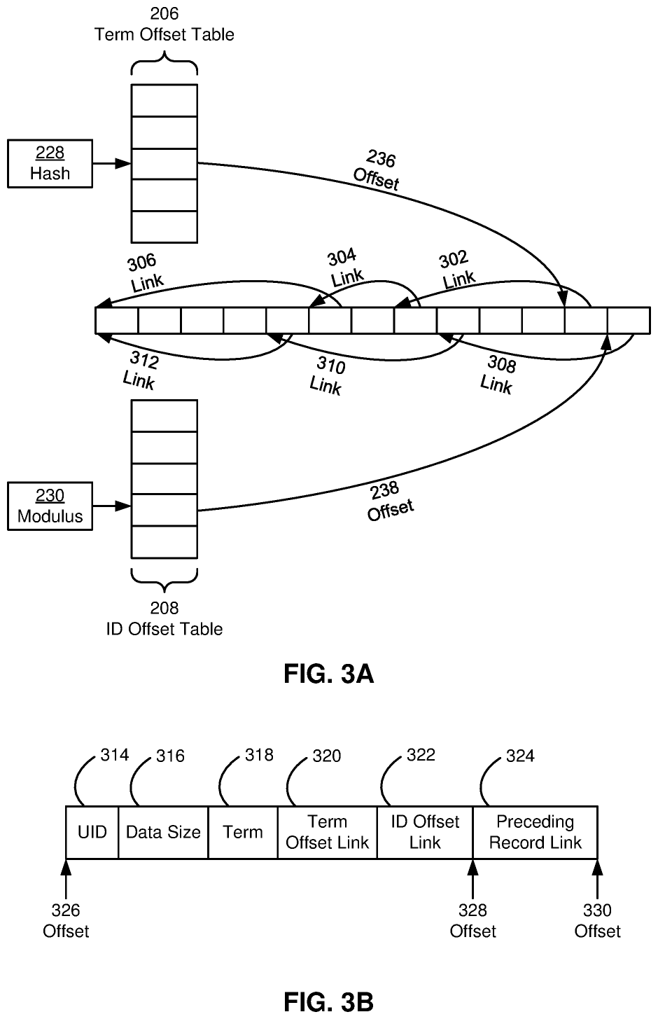

The operation of query-processing apparatus 204 in performing forward lookup 220 and reverse lookup 222 is illustrated using the example term offset table 206, ID offset table 208, and record store 210 of FIG. 3A and the example record in FIG. 3B. As shown in FIG. 3B, each record in record store 210 includes a starting offset 326 and an ending offset 330; the ending offset 330 is the same as the starting offset of the next record in record store 210. Each record also includes a field 314 storing an integer UID, a field 316 storing the data size (e.g., number of bytes) of a term mapped to the UID, and a field 316 storing the value of the term (e.g., a string).

Each record includes a field 320 storing a term offset link to a second previous record in record store 210 with a term that produces the same index into term offset table 206 as the term in field 318. For example, field 320 stores a delta (e.g., the number of bytes) between offset 326 and a corresponding starting offset of the second previous record. Each record also includes a field 322 storing an ID offset link to a first previous record in record store 210 with a UID that generates the same index into ID offset table 208 as the UID in field 314. For example, field 322 stores a delta (e.g., the number of bytes) between offset 326 and a corresponding starting offset of the first previous record.

Finally, each record includes a field 324 that stores a preceding record link to the preceding record in record store 210. For example, field 324 stores the delta (e.g., the number of bytes) between an offset 328 of the beginning of field 324 and the starting offset 326 of the record.

In one or more embodiments, fields 320-324 are stored in a compressed, reverse-readable format to reduce the size of the record and facilitate reverse traversal of data in the record. In some embodiments, the compressed, reverse-readable format includes a format that is described in U.S. Pat. No. 10,037,148 (issued 31 Jul. 2018), entitled “Facilitating Reverse Reading of Sequentially Stored, Variable-Length Data,” which is incorporated herein by reference.

As shown in FIGS. 2 and 3A, query-processing apparatus 204 performs forward lookup 220 by applying hash function 254 to term 224 to produce hash 228, which is used as an index into term offset table 206. Next, query-processing apparatus 204 obtains an offset 236 into record store 210 from the corresponding term offset table 206 entry at the index. Query-processing apparatus 204 then reads the value from field 318 in the record at offset 236. If field 318 matches term 224, query-processing apparatus 204 returns a corresponding UID 244 for term 224 as the value in field 314 from the same record.

If field 318 in the record at offset 236 does not match term 224, query-processing apparatus 204 traverses a chain 240 of term offset links 302-306 that connect the record at offset 236 with a series of previous records in record store 210 that map to the same hash 228 and term offset table 206 index. More specifically, query-processing apparatus 204 uses the term offset link 302 in field 320 of the record at offset 236 to compute the offset of a first previous record with a term that produces the same index into term offset table 206 as the term in the record at offset 236. Next, query-processing apparatus 204 compares field 318 in the first previous record to term 224. If the terms match, query-processing apparatus 204 returns UID 244 as the value in field 314 from the first previous record.

If field 318 in the first previous record does not match term 224, query-processing apparatus 204 uses the term offset link 304 in field 320 of the first previous record to compute the offset of a second previous record with a term that produces the same index into term offset table 206 as the terms in the first previous record and the record at offset 236. Query-processing apparatus 204 compares field 318 in the second previous record to term 224. If the terms match, query-processing apparatus 204 returns UID 244 as the value in field 314 from the second previous record.

If field 318 in the second previous record does not match term 224, query-processing apparatus 204 uses the term offset link 306 in field 320 of the second previous record to compute the offset of a third previous record with a term that produces the same index into term offset table 206 as the terms in the second previous record, the first previous record, and the record at offset 236. Query-processing apparatus 204 compares field 318 in the third previous record to term 224. If the terms match, query-processing apparatus 204 returns UID 244 as the value in field 314 from the third previous record.

If the terms do not match, query-processing apparatus 204 reads field 320 in the third previous record and determines that the third previous record is the end of chain 240 (i.e., the third previous record is the first record in record store 210 with a term that maps to the same term offset table 206 index as the term in the record at offset 236). Because the term is not found in record store 210, query-processing apparatus 204 performs operations for adding a mapping of the term to a new UID 244 to index 202.

To add a mapping of a given term 224 to a new UID 244 to index 202, query-processing apparatus 204 sets the value of UID 244 to a counter 250 representing the next available UID in the system. Query-processing apparatus 204 also increments counter 250 to indicate that the previous value of counter 250 has been used as a UID.

Next, query-processing apparatus 204 uses hash function 252 to calculate hash 228 from term 224 and uses hash 228 as a first index into term offset table 206. Query-processing apparatus 204 saves the first offset (e.g., offset 236) stored at the first index and appends a new record to the end of record store 210. Within the new record, query-processing apparatus 204 writes UID 244 to field 314, the size of term 224 to field 316, and the value of term 224 to field 318. Query-processing apparatus 204 also calculates a first delta from the starting offset of the new record to the saved first offset, and stores the first delta in field 322. If the term offset table 206 entry at the first index does not store a valid offset value, query-processing apparatus 204 sets field 322 in the new record to 0 or to another value indicating that no previous record maps to the first index into term offset table 206.

Query-processing apparatus 204 also uses modulo operation 254 to calculate a modulus 230 from UID 244 and uses modulus 230 as a second index into ID offset table 208 from the new UID. Query-processing apparatus 204 saves the second offset (e.g., offset 238) stored at the second index, calculates a second delta from the starting offset of the new record to the saved second offset, and stores the second delta in field 322 of the new record. If the ID offset table 208 entry at the second index does not store a valid offset value, query-processing apparatus 204 sets field 322 to 0 or to another value indicating that no previous record maps to the second index into ID offset table 208.

Query-processing apparatus 204 then calculates the delta between offset 328 at the end of field 322 and the starting offset 236 of the new record and writes the delta to field 324 in the new record. Finally, query-processing apparatus 204 updates the first index into term offset table 206 and the second index into ID offset table 208 with offset 326.

To perform reverse lookup 224, query-processing apparatus applies modulo operation 254 to a given UID 226 to produce modulus 230, which is used as an index into ID offset table 208. Next, query-processing apparatus 204 obtains an offset 238 into record store 210 from the ID offset table 208 entry at the index. Query-processing apparatus 204 then reads the value from field 314 in the record at offset 238. If field 314 matches UID 226, query-processing apparatus 204 returns a corresponding term 246 for UID 226 as the value in field 318 from the same record.

If field 314 in the record at offset 238 does not match UID 226, query-processing apparatus 204 traverses a chain 242 of ID offset links 308-312 that connect the record at offset 238 with a series of previous records in record store 210. More specifically, query-processing apparatus 204 determines the number of links 308-312 separating the UID in field 314 and UID 226 (e.g., by dividing the difference between the two UIDs by the number of entries in ID offset table 208 and/or the divisor of modulo operation 254). Query-processing apparatus 204 then uses field 322 to traverse the determined number of links 308-312 until the record containing UID 226 is reached. Finally, query-processing apparatus 204 returns term 246 as the value in field 318 from the same record.

In some embodiments, query-processing apparatus 204 reduces memory usage by omitting ID offset table 208 from index 202 and excluding field 322 from each record in record store 210. In these embodiments, query-processing apparatus 204 performs reverse lookup 224 using traversals 232 of records in record store 210. In particular, query-processing apparatus 204 performs a reverse traversal of records in record store 210, starting at the last record. During the reverse traversal, query-processing apparatus 204 uses the term offset link in field 320 of the last record to “jump” to an earlier record in record store 210. Query-processing apparatus 204 optionally repeats the process with each earlier record until a record with a UID that precedes UID 226 is reached. Query-processing apparatus 204 then iterates forward from the record and/or backwards from the subsequent record with a term offset link to the record until the record containing UID 226 is reached. Finally, query-processing apparatus 204 returns term 246 as the value in field 318 from the record containing UID 226.

Query-processing apparatus 204 additionally includes functionality to optimize forward lookup 220, reverse lookup 222, addition of new mappings to index 202, and/or other operations involving index 202 and/or term-UID mappings. First, query-processing apparatus 204 uses a number of mapped byte buffers to access memory-mapped portions of record store 210. The buffers are generated to align with starting offsets of records in record store 210, slightly overlap with one another, and ordered sequentially from the beginning of record store 210 to the end of record store 210. To write a new record to record store 210, query-processing apparatus 204 accesses the last available buffer. If the last buffer lacks the capacity to accommodate the new record, query-processing apparatus 204 creates a new buffer that begins at the end of record store 210 and writes the new record using the new buffer. To read a record from record store 210, query-processing apparatus 204 identifies the first buffer that contains the starting offset of the record and uses the identified buffer to read the record. If the identified buffer does not span the entirety of the record, query-processing apparatus 204 completes the read using the subsequent buffer.

Second, query-processing apparatus 204 synchronizes writes that append new records to the end of record store 210. During a write, query-processing apparatus 204 acquires a lock on writing to record store 210 and uses counter 250 to generate a new UID for a term. Query-processing apparatus 204 optionally compares the UID in the last record of record store 210 with counter 250 to verify that the new UID has not already been added to record store 210.

Next, query-processing apparatus 204 writes the new UID and corresponding fields (e.g., fields 316-324) into a new record at the end of record store 210 and updates term offset table 206 and/or ID offset table 208 to reflect the new record. Query-processing apparatus 204 then increments counter 250 and updates the end-of-file marker for record store 210 to include the new record before releasing the lock.

Third, query-processing apparatus 204 writes terms to record store 210 by increasing term frequency, so that frequently used terms appear later in record store 210 and thus are faster to retrieve. If index 202 omits ID offset table 208 and ID offset links among the records, query-processing apparatus 204 reassigns UIDs to terms in the reordered records, so that the UIDs appear in sequential increasing order in the reordered records. On the other hand, if index 202 includes ID offset table 208, query-processing apparatus 204 can reorder records in record store 210 (e.g., in order of increasing term frequency) without reassigning UIDs to terms in the records. In this instance, query-processing performs reverse lookup 222 by checking every UID in chain 242 instead of traversing a known number of links in chain 242 to arrive at a record with the desired UID 226.

Conversely, query-processing apparatus 204 writes term-UID mappings to record store 210 as the terms appear in data repository 134 and/or are sent to query-processing apparatus 204 for insertion into index 202. After a significant proportion of expected terms have been added to index 202, query-processing apparatus 204 reverses the ordering of records in record store 210, so that more frequent terms that were encountered earlier by query-processing apparatus 204 are closer to the end of record store 210 than less frequent terms that were encountered later by query-processing apparatus 204.

By storing mappings of terms to UIDs in a memory-mapped log-structured record store 210, the disclosed embodiments reduce the memory footprint of the mappings. At the same time, the use of an in-memory term offset table 206 and/or ID offset table 208 with corresponding chains of references within records in the log-structured record store 210 expedites lookup of UIDs for terms (or terms for UIDs) without incurring significant memory overhead.

In contrast, conventional techniques store term-UID mappings in an in-memory two-way concurrent map. The two-way concurrent map includes one set of mappings from string terms to integer UIDs and another set of mappings from integer UIDs to string terms. Because two mappings are maintained for each term-UID pair, the two-way concurrent map occupies a significant amount of memory, which can lead to unexpected latency during garbage collection cycles and prevent other processes, services, and/or applications from using the memory.

The conventional techniques also, or instead, use a hash function to compute an integer hash value representing an ID from a string term. In these instances, the uniqueness of the ID cannot be guaranteed, since the likelihood of hash collisions increases significantly with the number of terms. In addition, the hash function is used in lieu of storing mappings between terms and IDs, which prevents reverse lookup of terms given the IDs. Such lack of reverse lookup additionally prevents the context associated with a given ID from being established, which interferes with debugging, troubleshooting, and/or analysis related to the ID and/or use of the ID as a representation of the corresponding term. Consequently, the disclosed embodiments provide technological improvements in applications, tools, computer systems, and/or environments for generating, storing, and/or looking up term-UID mappings.

Those skilled in the art will appreciate that the system of FIG. 2 may be implemented in a variety of ways. First, query-processing apparatus 204 and data repository 134 may be provided by a single physical machine, multiple computer systems, one or more virtual machines, a grid, a cluster, one or more databases, one or more filesystems, and/or a cloud computing system. Query-processing apparatus 204 may further execute in an offline, online, and/or on-demand basis to accommodate requirements or limitations associated with the processing, performance, or scalability of the system; the availability of new terms in data repository 134; and/or subsequent use of the terms and/or UIDs by components interfacing with query-processing apparatus 204.

Second, the size of term offset table 206 and/or ID offset table 208 may be selected to balance memory usage of the system with lookup speed associated with forward lookup 220 and/or reverse lookup 222. As mentioned above, the system may omit ID offset table 208 and ID offset links in records in record store 210 to reduce the memory and/or storage consumption of index 202, at the cost of a slower reverse lookup 222. Similarly, the number of entries in term offset table 206 and/or ID offset table 208 may be selected to balance the memory usage of the table with the speed of the corresponding lookup; a larger table consumes more memory but results in faster lookup time, while a smaller table consumes less memory but increases lookup time.

Third, the functionality of the system may be adapted to different types of terms and/or use cases. For example, the system may be used to perform entity-name tracking in a computer aided design (CAD) application and/or map one or more fields in a database to a primary key.

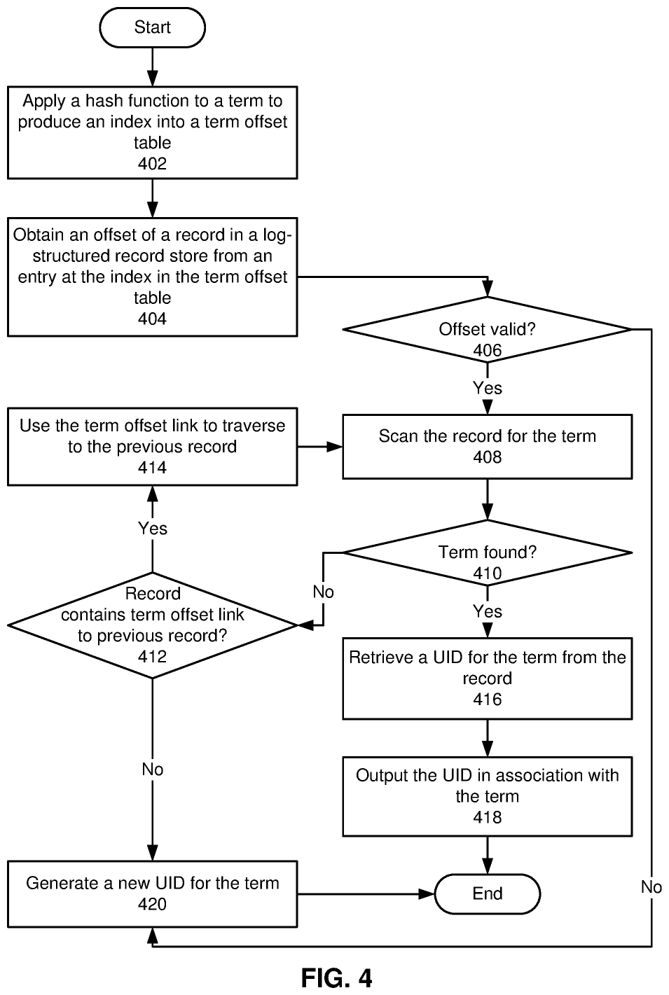

FIG. 4 shows a flowchart illustrating a process of performing a forward lookup of a UID for a term in accordance with the disclosed embodiments. In one or more embodiments, one or more of the steps may be omitted, repeated, and/or performed in a different order. Accordingly, the specific arrangement of steps shown in FIG. 4 should not be construed as limiting the scope of the embodiments.

Initially, a hash function is applied to a term to produce an index into a term offset table (operation 402). For example, the hash function produces integer values in the range of indexes in the term offset table. When the term offset table has fewer entries than the number of terms, multiple term values can produce the same index into the term offset table.

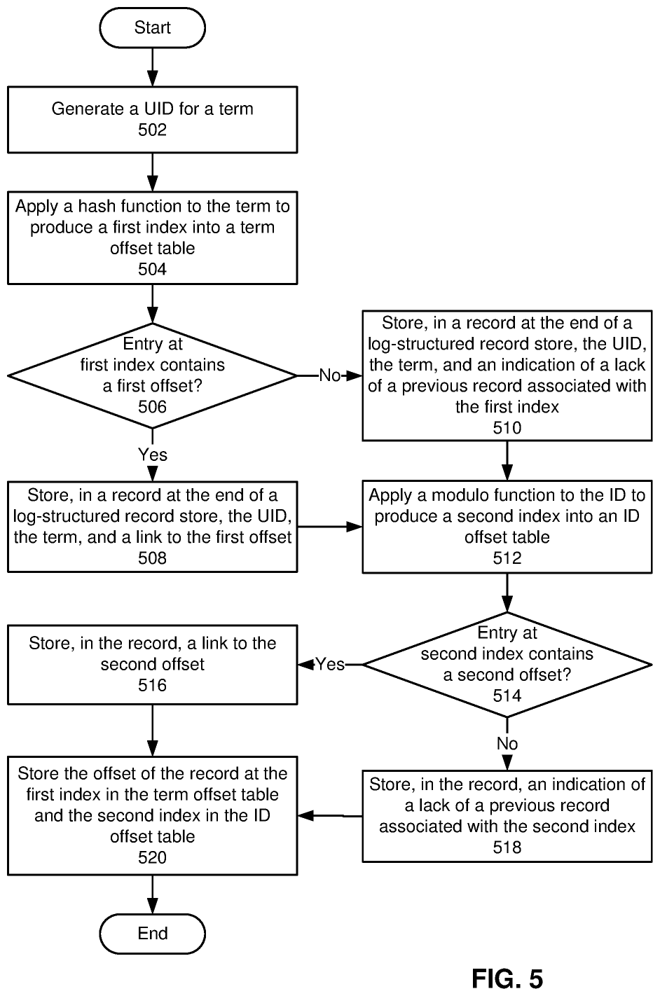

Next, an offset of a record in a log-structured record store is obtained from an entry at the index in the term offset table (operation 404). Subsequent processing of the forward lookup is based in the validity of the offset (operation 404) at the term offset table index. For example, the term offset table entry at the index stores an invalid offset when no previous terms have produced the same index into the term offset table. If the offset at the index is invalid, the log-structured record store lacks a mapping of the term to a UID. Instead, a new UID for the term is generated (operation 420), as described in further detail below with respect to FIG. 5.

If the offset at the index is valid, the record at the offset is scanned for the term (operation 408), and subsequent processing is performed based on the presence or absence of the term (operation 410) in the record. If the term is found in the record, a UID for the term is retrieved from the record (operation 416) and outputted in association with the term (operation 418). For example, the UID is provided in response to a forward lookup request that includes the term as a parameter.

If the term is not found in the record, subsequent processing is performed based on the presence or absence of a term offset link from the record to a previous record (operation 412). If the record contains a term offset link to a previous record, the term offset link is used to traverse to the previous record (operation 414). For example, the term offset link specifies the number of bytes between the record and the previous record. As a result, the traversal may be performed by subtracting the number of bytes from the starting offset of the record and “jumping” to the resulting offset of the previous record. Scanning of the record at the resulting offset is then performed to locate the term in the record (operations 408-410) and output the corresponding UID when the term is found (operations 416-418). Conversely, if the term is not found in the record, the record is examined for a term offset link (operation 412), and the term offset link is used to traverse to an even earlier record (operation 414) in the record store.

If a given record contains neither a term offset link to a previous record nor the term, the record is the first record in the log-structured record store that maps to the index in the term offset table, and no UID currently exists for the term. As a result, the log-structured record store lacks a mapping of the term to a UID, and a new UID for the term is generated (operation 420).

FIG. 5 shows a flowchart illustrating a process of storing a term-UID mapping in accordance with the disclosed embodiments. In one or more embodiments, one or more of the steps may be omitted, repeated, and/or performed in a different order. Accordingly, the specific arrangement of steps shown in FIG. 5 should not be construed as limiting the scope of the embodiments.

First, a UID for a term is generated (operation 502). For example, the UID is obtained as the value of a counter that tracks the next available UID in a system that maintains term-UID mappings. Next, a hash function is applied to the term to produce a first index into a term offset table (operation 504).

Subsequent processing is performed based on the presence or absence of a first offset in the entry at the first index in the term offset table (operation 506). For example, the first offset is found in the term offset table entry at the first index when term-UID mappings have previously been generated for one or more terms that map to the first index in the term offset table. If the entry does not contain an offset, the UID, term, and an indication of a lack of a previous record associated with the first index is stored in a record at the end of a log-structured record store (operation 510). If the entry contains an offset, the UID, term, and a link to the first offset are stored in the record at the end of the log-structured record store (operation 508).

A modulo function is then applied to the ID to produce a second index into an ID offset table (operation 512), and subsequent processing is performed based on the presence or absence of a second offset in the entry at the second index of the ID offset table (operation 514). For example, the second offset is found in the ID offset table entry at the second index when term-UID mappings have previously been generated for one or more IDs that map to the second index in the ID offset table. If the entry does not contain an offset, an indication of a lack of previous record associated with the second index is stored in the record (operation 518). If the entry contains the second offset, a link to the second offset is stored in the record (operation 520).

Finally, the offset of the record is stored at the first index in the term offset table and the second index in the ID offset table (operation 520). In turn, the record's offset is retrieved during subsequent lookups involving terms that map to the first index in the term offset table and/or IDs that map to the second index in the ID offset table, and fields in the record are used to complete the lookups and/or reach other records in the record store that can be used to complete the lookups.

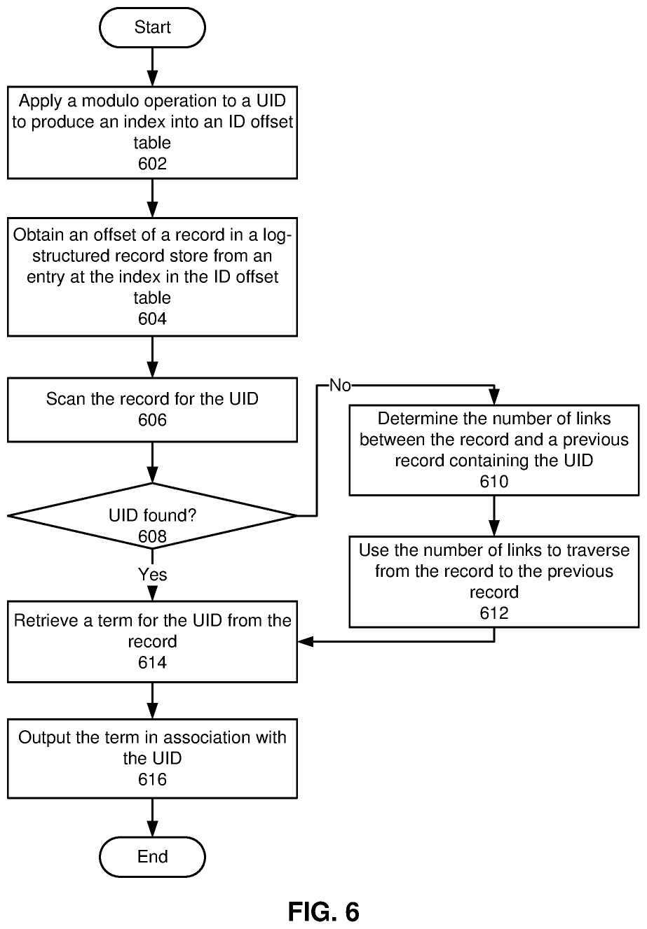

FIG. 6 shows a flowchart illustrating a process of performing a reverse lookup of a term for a UID in accordance with the disclosed embodiments. In one or more embodiments, one or more of the steps may be omitted, repeated, and/or performed in a different order. Accordingly, the specific arrangement of steps shown in FIG. 6 should not be construed as limiting the scope of the embodiments.

Initially, a modulo operation is applied to the UID to produce an index into an ID offset table (operation 602). For example, the modulo operation includes a divisor that is set to the size of the ID offset table. When the ID offset table has fewer entries than the number of UIDs, multiple UID values produce the same index into the ID offset table.

Next, an offset of a record in a log-structured record store is obtained from an entry at the index in the ID offset table (operation 604), and the record at the offset is scanned for the UID (operation 606). Subsequent processing is performed based on the presence or absence of the UID (operation 608) in the record. If the UID is found in the record, a term for the UID is retrieved from the record (operation 614) and outputted in association with the UID (operation 616). For example, the term is provided in response to a reverse lookup request that includes the UID as a parameter.

If the term is not found in the record, the number of links between the record and previous record containing the UID is determined (operation 610). For example, the number of links is determined by dividing the number of records between the record and the previous record by the divisor of the modulo operation. The number of links is used to traverse from the record to the previous record (operation 612), and the term for the UID is then retrieved from the record and outputted (operations 614-616).

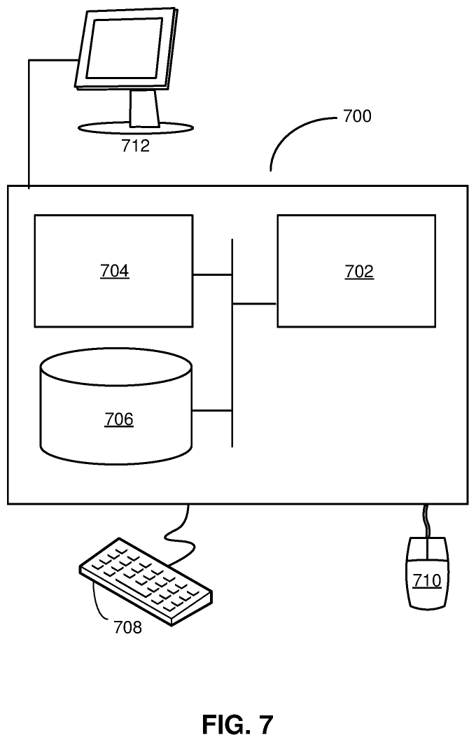

FIG. 7 shows a computer system in accordance with the disclosed embodiments. Computer system 700 includes a processor 702, memory 704, storage 706, and/or other components found in electronic computing devices. Processor 702 may support parallel processing and/or multi-threaded operation with other processors in computer system 700. Computer system 700 may also include input/output (I/O) devices such as a keyboard 708, a mouse 710, and a display 712.

Computer system 700 may include functionality to execute various components of the present embodiments. In particular, computer system 700 may include an operating system (not shown) that coordinates the use of hardware and software resources on computer system 700, as well as one or more applications that perform specialized tasks for the user. To perform tasks for the user, applications may obtain the use of hardware resources on computer system 700 from the operating system, as well as interact with the user through a hardware and/or software framework provided by the operating system.

In one or more embodiments, computer system 700 provides a system for processing data. The system includes a query-processing apparatus, which may alternatively be termed or implemented as a module, mechanism, or other type of system component. The query-processing apparatus applies a hash function to a first term to produce a first index into a term offset table. Next, the query-processing apparatus obtains, from a first entry at the first index in the term offset table, a first offset of a first record in a log-structured record store. The query-processing apparatus retrieves a first UID for the first term from the first record and/or another record that is linked to the first record via a corresponding mapping to the first index. Finally, the query-processing apparatus outputs the first UID in association with the first term.

The query-processing apparatus also, or instead, generates a second UID for a second term. Next, the query-processing apparatus applies the hash function to a second term to produce a second index into the term offset table. The query-processing apparatus obtains a second offset into the log-structured record store from a second entry at the second index in the term offset table. The query-processing apparatus then stores, in a second record at an end of the log-structured record store, a second UID, the second term, and a first link to the second offset. Finally, the query-processing apparatus stores, in the second entry at the second index in the term offset table, a third offset of the second record in the log-structured record store.

In addition, one or more components of computer system 700 may be remotely located and connected to the other components over a network. Portions of the present embodiments (e.g., query-processing apparatus, index, data repository, online network, etc.) may also be located on different nodes of a distributed system that implements the embodiments. For example, the present embodiments may be implemented using a cloud computing system that performs forward and reverse lookups of term-UID mappings for a set of remote clients.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor (including a dedicated or shared processor core) that executes a particular software module or a piece of code at a particular time, and/or other programmable-logic devices now known or later developed. When the hardware modules or apparatus are activated, they perform the methods and processes included within them.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A method, comprising:
applying, by one or more computer systems, a hash function to a first term comprising a string to produce a first index into a term offset table;
obtaining, by the one or more computer systems from a first entry at the first index in the term offset table, a first offset of a first record in a log-structured record store;
upon locating the first term in the first record, retrieving a first unique identifier (UID) for the first term from the first record; and
outputting the first UID in association with the first term.

2. The method of claim 1, further comprising:
upon verifying an absence of a second term in the first record at the offset in the log-structured record store, retrieving, from the first record, a first link to a second record in the log-structured record store that maps to the first index in the term offset table; and
scanning the second record for the second term.

3. The method of claim 2, further comprising:
upon verifying the absence of the second term in the second record, scanning additional records linked to the second record in the log-structured record store for the second term.

4. The method of claim 3, further comprising:
upon verifying the absence of the second term in the additional records, generating a new UID for the second term.

5. The method of claim 1, further comprising:
generating a second UID for a second term;
applying the hash function to the second term to produce a second index into the term offset table;
obtaining a second offset into the log-structured record store from a second entry at the second index in the term offset table;
storing, in a second record at an end of the log-structured record store, the second UID, the second term, and a first link to the second offset; and
storing, in the second entry at the second index in the term offset table, a third offset of the second record in the log-structured record store.

6. The method of claim 1, further comprising:
generating a second UID for a second term;
applying the hash function to the second term to produce a second index into the term offset table;
upon verifying a lack of offset into the log-structured record store from a second entry at the second index in the term offset table, storing, in a second record at an end of the log-structured record store, the second UID, the second term, and an indication of a lack of a previous record associated with the second index; and
storing, in the second entry at the second index in the term offset table, a second offset of the second record in the log-structured record store.

7. The method of claim 1, further comprising:
scanning one or more chains of records in the log-structured record store for a second record comprising a second UID; and
retrieving a second term for the second UID from the second record.

8. The method of claim 1, further comprising:
storing, in the log-structured record store, a set of terms in a set of records that is ordered by increasing term frequency.

9. The method of claim 1, further comprising:
storing the log-structured record store in one or more memory-mapped files.

10. The method of claim 1, further comprising:
maintaining the term offset table in memory on the one or more computer systems.

11. A method, comprising:
applying, by one or more computer systems, a modulo operation to a first unique identifier (UID) to produce a first index into an identifier (ID) offset table;
obtaining, by the one or more computer systems, a first offset into a log-structured record store from a first entry at the first index in the ID offset table;
upon locating the first UID in a first record at the offset in the log-structured record store, retrieving a first term mapped to the first UID from the first record; and
outputting the first term in association with the first UID.

12. The method of claim 11, further comprising:
upon verifying an absence of a second UID in the first record at the offset in the log-structured record store, determining a number of links between the first record and a second record containing the second UID by dividing a number of records between the first record and the second record by a divisor of the modulo operation;
traversing the number of links from the first record to the second record in the log-structured record store; and
retrieving a second term for the second UID from the second record.

13. The method of claim 11, further comprising:
generating a second UID for a second term;
applying the modulo operation to the second UID to produce a second index into the ID offset table;
obtaining a second offset into the log-structured record store from a second entry at the second index in the ID offset table;
storing, in a second record at an end of the log-structured record store, the second UID, the second term, and a first link to the second offset; and
storing, in the second entry at the second index in the ID offset table, a third offset of the second record in the log-structured record store.

14. The method of claim 13, further comprising:
applying a hash function to the second term to produce a third index into a term offset table;
obtaining a fourth offset into the log-structured record store from a third entry at the third index in the term offset table;
storing a second link to the fourth offset in the second record; and
storing, in the third entry at the third index in the term offset table, the third offset of the second record.

15. The method of claim 13, further comprising:
storing, at an end of the second record, a link to a beginning of the second record.

16. The method of claim 13, further comprising:
storing the log-structured record store in one or more memory-mapped files; and
maintaining the term offset table and the ID offset table in memory on the one or more computer systems.

17. The method of claim 13, wherein generating the second UID for the second term comprises:
setting the second UID to a counter representing a next available UID.

18. The method of claim 11, further comprising:
generating a second UID for a second term;
applying the modulo operation to the second UID to produce a second index into the ID offset table;
upon verifying a lack of offset into the log-structured record store from a second entry at the second index in the ID offset table, storing, in a second record at an end of the log-structured record store, the second UID, the second term, and an indication of a lack of a previous record associated with the second index; and
storing, in the second entry at the second index in the ID offset table, a second offset of the second record in the log-structured record store.

19. A non-transitory computer-readable storage medium storing instructions that when executed by a computer cause the computer to perform a method, the method comprising:
applying a hash function to a first term comprising a string to produce a first index into a term offset table;
obtaining, from a first entry at the first index in the term offset table, a first offset of a first record in a log-structured record store;
upon locating the first term in the first record, retrieving a first unique identifier (UID) for the first term from the first record; and
outputting the first UID in association with the first term.

20. The non-transitory computer-readable storage medium of claim 19, the method further comprising:
generating a second UID for a second term;
applying the hash function to the second term to produce a second index into the term offset table;
obtaining a second offset into the log-structured record store from a second entry at the second index in the term offset table;
storing, in a second record at an end of the log-structured record store, the second UID, the second term, and a first link to the second offset; and
storing, in the second entry at the second index in the term offset table, a third offset of the second record in the log-structured record store.
